(19) United States
(12) Patent Application Publication
(10) Pub. No.: US 2012/0150741 A1
(43) Pub. Date: Jun. 14, 2012

(54) MOBILE DEVICE FOR PROVIDING SMART WALLET SERVICE AND LAYER STRUCTURE FOR OPERATING SMART WALLET SERVICE

(75) Inventors: Sangrae CHO, Daejeon (KR); Dae Seon CHOI, Daejeon (KR); Young Seob CHO, Daejeon (KR); Jong-Hyouk NOH, Daejeon (KR); Soo Hyung KIM, Daejeon (KR); Seung-Hyun KIM, Daejeon (KR); Seung Hun JIN, Daejeon (KR); Seok Hyun KIM, Daejeon (KR); Hyun sook CHO, Daejeon (KR)

(73) Assignee: Electronics and Telecommunications Research Institute, Daejeon (KR)

(21) Appl. No.: 13/324,506

(22) Filed: Dec. 13, 2011

(30) Foreign Application Priority Data
Dec. 13, 2010 (KR) 10-2010-0127083

(51) Int. Cl. G06Q 20/36

(52) U.S. Cl. 705/41

(57) ABSTRACT

A smart wallet service module includes: a management unit for installing, activating, and terminating a smart wallet service or receiving and managing a user's setting; a security unit for providing an authentication service through an authenticated certificate or electronic signature; a storage unit for storing data in a database of a mobile device and managing the stored data; and a functional unit connected to a storage medium inside the mobile device and providing a service related to electronic commerce or credit card issuing.

### CROSS-REFERENCE TO RELATED APPLICATION(S)

The present invention claims priority of Korean Patent Application No. 10-2010-0127083, filed on Dec. 13, 2010, which is incorporated herein by reference.

### FIELD OF THE INVENTION

The present invention relates to management technology of a mobile identity, and more particularly, to a mobile device for providing a smart wallet service capable of effectively and safely managing a mobile identity thereof and a layer structure for operating the smart wallet service.

### BACKGROUND OF THE INVENTION

Conventional ID management technology which was used in a centralized and integrated authentication type has developed into ID federation technology which shares personal information and exchanges authentication information linking up with user accounts in different domains. Furthermore, as users' privacy protection is emphasized, the ID management technology has developed into user-oriented ID management technology. Currently, as the mobile environment is widely used, the ID management technology has developed into management technology of a mobile identity.

The user-oriented ID management technology with a conventional technology level provides user convenience and user-oriented personal information control, and the spread of the user-oriented ID management has been expanded. However, the conventional ID management technology has a limit to supporting a mobile ID. Since the ID management technology was developed for a personal computer (PC), it cannot deal with the mobile environment. Further, the ID management technology operates only in a PC having it installed therein and thus has a data mobility limit. Furthermore, the ID management technology does not consider a loss or theft which may occur while a mobile device is carried, and does not support an identity checking function. In addition, the ID management technology does not contain dynamic personal information or various physical authentication/payment methods among mobile IDs, and does not include a technical concept required for an ID-based service.

With the performance improvement of mobile equipments such as smart phones and the expansion of the u-IT service using mobile phones, a variety of identity information is used in the mobile environment. Mobile IDs may cause management inconvenience, and are exposed to various threats and privacy violations. Therefore, technology capable of safely and conveniently managing and using mobile IDs is required, and there is increasing demand for a method for providing an enhanced service in the on/off environment by integrating and connecting mobile IDs.

Meanwhile, the dynamic personal information including user's movements such as a purchase record, a preference, and a position among the mobile IDs corresponds to higher-value added information which is capable of providing an enhanced and customized service based on the dynamic personal information. Therefore, there is a demand for a base structure for utilizing such information without privacy violations.

### SUMMARY OF THE INVENTION

In view of the above, the present invention provides a mobile device for providing a smart wallet service capable of effectively and safely managing a mobile identity thereof and a layer structure for operating the smart wallet service.

Further, present invention provides a layer structure for safely managing various mobile identities, which are used in a mobile device for an on/off line service, under a single system.

In accordance with a first aspect of the present invention, there is provided a smart wallet service module for use in a mobile device, which includes:

a management unit for installing, activating, and terminating a smart wallet service or receiving and managing a user's setting;

a security unit for providing an authentication service through an authenticated certificate or electronic signature;

a storage unit for storing data in a database and managing the stored data; and

a functional unit connected to a storage medium and providing a service related to electronic commerce or credit card issuing.

Preferably, the smart wallet service module is connected to a user interface unit and an input/output unit of the mobile device through a contents provider for supporting access to the information stored in the database and a service interface for supporting a function of on/off line payment or credit card issuing.

Preferably, the functional unit is connected to the storage medium through a universal IC card (UICC) API and provides the service related to electronic commerce and credit card issuing.

Preferably, the storage medium comprises a universal subscriber identity unit (USIM).

In accordance with a second aspect of the present invention, there is provided a layer structure for operating a smart wallet service module, which includes:

an upper layer and a lower layer,

wherein the upper layer includes:

a presentation layer for processing a user interface which receives an input from a user and outputs a result; and

a logic layer for processing a cooperation and interaction between calculations and services, receiving data from the lower layer, and providing a result obtained by processing the received data to the presentation layer,

wherein the lower layer includes:

a security layer for handling security;

a data layer for storing and managing data; and

a USIM layer for controlling a USIM mounted in a mobile device.

Preferably, the security layer handles security of user authentication and risk-based authentication, and provides a function for using an authenticated certificate.

Preferably, the USIM layer manages credit card information required for on/off line payment, and provides a function related to credit card issuing.

Preferably, the layer structure is divided into a utilization and management processor comprising the presentation layer and the logic layer and a security and storage processor comprising the security layer, the data layer, and the USIM layer, and

data transmission and reception between the use and management processor and the security and storage processor is performed through a contents provider inside the mobile device, and an operation between the use and management processor and the security and storage processor is performed through a service interface inside the mobile device.

### BRIEF DESCRIPTION OF THE DRAWINGS

The above and other objects and features of the present invention will become apparent from the following description of embodiments given in conjunction with the accompanying drawings, in which:

FIG. 1 is a diagram illustrating a mobile identity framework for explaining a management of a mobile identity of smart mobile equipment in accordance with an embodiment of the present invention;

FIG. 2 is a block diagram of a mobile device for providing a smart wallet service in accordance with the embodiment of the present invention; and

FIG. 3 is a logic structure diagram illustrating an operation of the smart wallet service in accordance with the embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

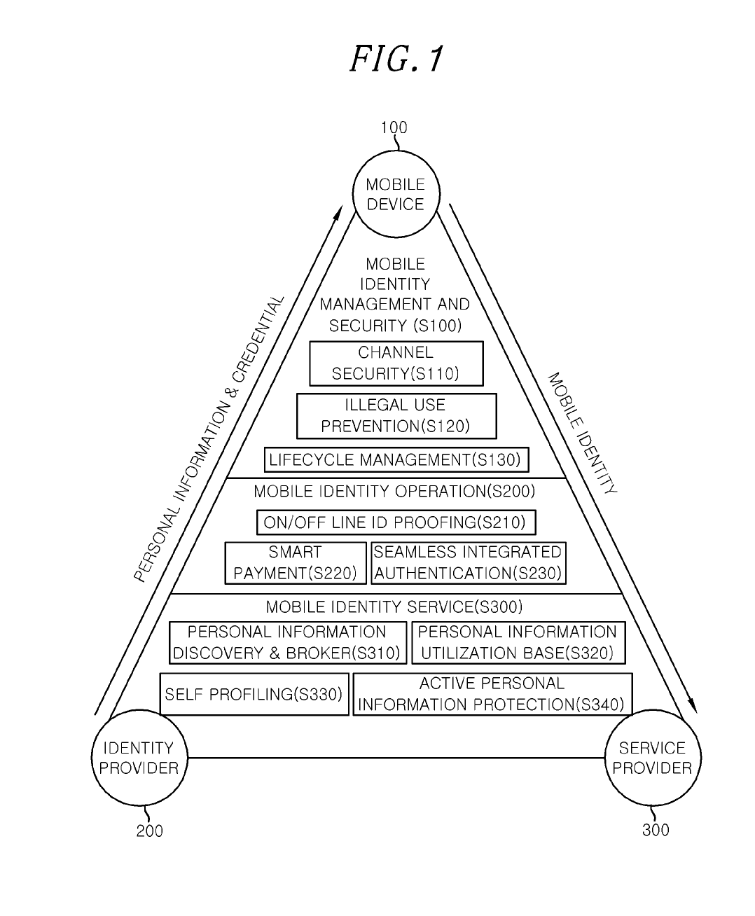

FIG. 1 is a diagram illustrating a mobile identity framework for explaining a management of a mobile identity apparatus of smart mobile equipment in accordance with an embodiment of the present invention.

Referring to FIG. 1, a management framework of a mobile identity includes a mobile device 100, an identity provider 200, and a service provider 300.

The identity provider 200 is an entity which issues an identity or credential to a user or entity and manages and maintains the issued identity or credential. For a mobile identity, the identity provider 200 provides an on/off line credential, payment information, position information and so on. The identity provider 200 serves to provide personal information and credential to the mobile device 100.

The mobile device 100 includes a portable device with mobility, in which application programs can be installed. The mobile device 100 has all functions of the management framework mounted therein. The mobile device 100 profiles, or process and combines a variety of identities provided from the identity provider 200, and provides the processed or combined identities to the service provider 300 so that the mobile device 100 enjoys a personalized or customized service provided from the service provider 300.

The service provider 300 includes an entity which receives the mobile identity of a user or entity from the mobile device 100 and provides a personalized or customized service.

Management and security of a mobile identity S100 is a component of the base of the management framework of the mobile identity and is mainly used by the mobile device 100, and serves to provide a basic security and identity management function to other components.

Life cycle management S130 is a unified processing component for integrally managing the mobile identities such as authentication and payment information used in an on/off line service, dynamic personal information, personal contexts, and preference information. The life cycle management S130 may include a user interface (UI) convenient and optimized to the mobile device 100 and a management protocol for issuing, updating, and discarding the mobile identity.

Illegal use prevention S120 includes a mobile device's user authentication technology for maintaining security without hurting user's convenience and an access control technology for management and utilization of the mobile identity. Furthermore, the illegal use prevention S120 may also include distance-based locking technology in which the mobile device 100 is logged in when close to a computer, and automatically logged out when remote from the computer.

In addition, the illegal use prevention S120 may further include a response technology to a device loss which monitors the mobile device 100 in real time when the mobile device 100 is lost, and performs a security function in accordance with a risk degree caused by the device loss.

Channel security S110 is a component for effectively establishing security channels which are frequently requested between infrastructure devices and the mobile device 100 having a limit in user interface at a near-field RF channel. The channel security S110 may include a user-friendly and primary reliability establishment technology, a effective authentication technology, and a key exchange technology.

Mobile identity operation S200 is a mobile device core component for supporting an enhanced utilization and interoperability of the mobile identities in an on/off line service.

On/off line ID proofing S210 is a component which receives a master identity issued through the mobile device 100 and generates an identity for each purpose, if necessary, in order to use and provide a safe identity substituting for a resident registration number in an on/off line environment. The identity for each purpose may be transmitted to the Internet and a near-field RF channel and generated in such a number type as to be used manually or verbally like a resident registration number. Here, the transmitted identity for each purpose prevents an illegal use through verification and cannot be reused.

Smart payment S220 includes a technology which searches for a purchase/payment service platform and protocol for securing interoperability between various payment and discount objects stored in the mobile device 100 and an optimal discount object among the payment and discount units. For Internet shopping, the smart payment S220 may include an intellectual purchase payment agent which provides price comparison and purchase assistance in an off-line purchase environment. Seamless integrated authentication S230 is a component of process which performs access control, device user authentication, and service user authentication via a near-field RF channel, using authentication information stored in the mobile device 100. The seamless integrated authentication S230 may include an integrated provisioning and integrated audit management technologies for an access control service and a device and intranet service and a technology for performing seamless authentication in connection with a user authentication session of a device such as a PC and service IDs.

The mobile identity service S300 basically provides a variety of interfaces required for developing mobile-identity-based services.

The service provided by the mobile framework applied to the embodiment of the present invention may provide a scheme that the identity provider 200 or service provider 300 exchanges a service in line with the mobile device 100.

Techniques for configuring the interfaces provided to the outside from the mobile framework will be described as follows.

Personal information utilization base S320 is a technology enabling that the mobile device 100 provides information accumulated through a self profiling to various service providers and receives personalized services from the service providers. The personal information utilization base S320 also provides a basic service for searching and using personal information stored in the mobile device 100. In order to provide the services, the personal information utilization base S320 provides a service interface which is the base of active personal information protection and discovery & broker.

Self profiling S330 is a technology which records dynamic personal information (entrance and exit, authentication, purchase, payment, and movements) generated while a smart client is used, and records personal contexts such as a user's position and surrounding environment monitored through the mobile device 100. The accumulated records may be analyzed to extract personal preferences or interests and standardize dynamic personal information and personal contexts.

Active personal information protection S340 is a technology which transmits a self profile and static personal information generated by the mobile device 100 in accordance with user's selection, without privacy violations. The active personal information protection S340 includes a user's personal information policy management technology considering the interface of the mobile device 100, a technology for automatically determining whether or not to provide personal information through a negotiation between policies of a user and an information consumer, and anonymization and pseudonymization technologies which determines an identity disclosure possibility through a combination of personal information to be provided and an existing provided history, thereby preventing the identity disclosure.

Personal information discovery & broker technology S310 includes a discovery service in which the service provider 300 searches for an individual having a specific personal information attribute, and a broker service in which the service provider 300 relays between a specific user and a specific service provider in order to provide an identity-based customized service. At this time, search and relay technologies which do not disclose a personal identity is included in a mobile-identity-based service development framework.

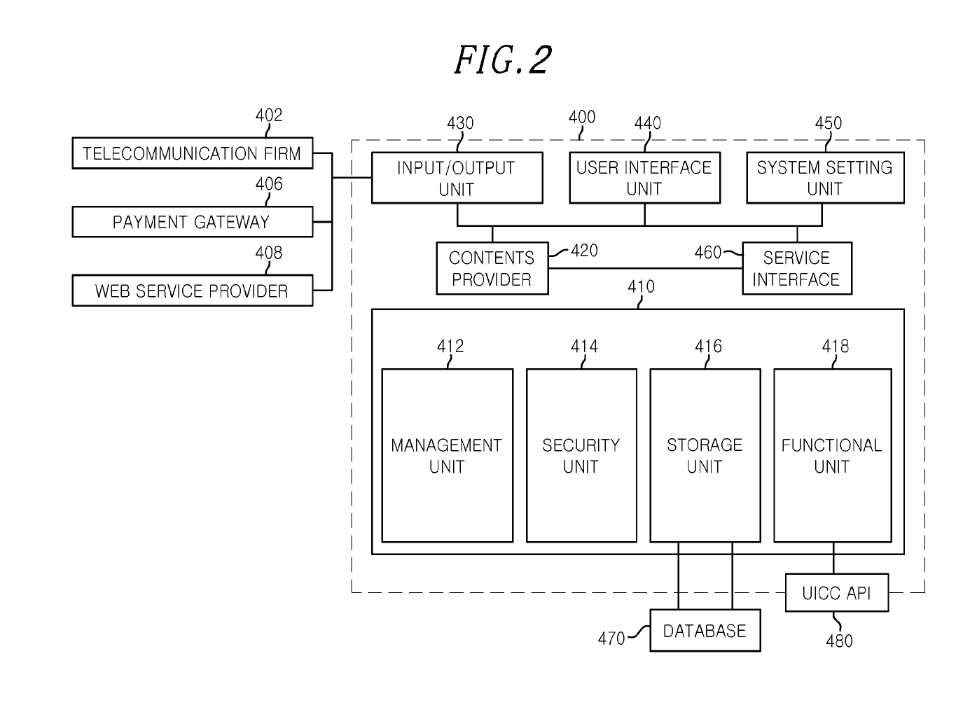

In order to develop the management framework of a mobile identity framework having the above-described configuration, a smart wallet service for managing a mobile identity needs be provided, which will be described with reference to FIG. 2.

FIG. 2 is a block diagram of a mobile device for providing the smart wallet service in accordance with an embodiment of the present invention.

Referring to FIG. 2, the mobile device 400 interworks with a telecommunication firm 402, a payment gateway 406, and a web service provider 408, and includes a smart wallet service module 410, a contents provider 420, an input/output unit 430, a user interface unit 440, a system setting unit 450, a service interface 460, and a database 470.

The smart wallet service module 410 in includes a management unit 412, a security unit 414, a storage unit 416, and a functional unit 418.

The management unit 412 provides a service which installs, activates, and terminates the smart wallet service module 410 and receives and manages user's settings.

The security unit 414 performs a basic user authentication and risk-based authentication and provides an authentication service through the authentication or an electronic signature using an authenticated certificate.

The storage unit 416 serves to store and safely manage various data used in the smart wallet service module 410 in the database 470. The functional unit 418 is connected to a universal subscriber identity unit (USIM) as a storage medium through a universal IC card (UICC) API (Application Programming Interface) 480 for providing services such as subscriber authentication, electronic commerce, and global roaming and provides a service required for processing functions related to on/off line payment and credit card issuing in the smart wallet service module 410. That is, the functional unit 418 communicates with the USIM through the UICC API 480 to provide the smart wallet service.

The user interface unit 440 or the input/output unit 430 may be connected to the smart wallet service module 410.

The contents provider 420 and the service interface 460 serve to assist the connection between the smart wallet service module 410 and the user interface unit 440 or the input/output unit 430.

The contents provider 420, which includes technology which is provided by a mobile operating system, for example, Android available from Google, freely calls the access of information stored in the database 470 from the upper level such that the information may be used. The contents provider 420 serves to provide card information, certificate information, and transaction information to the user interface unit 440 or an external application program.

The service interface 460 serves to provide additional functions or information which may not be provided through the contents provider 420. For example, the service interface 460 may provide an on/off line payment function and a credit card issuing function.

The input/output unit 430 serves to provide the service of the smart wallet service module 410 to the telecommunication firm 402, the payment gateway 406, and the web service provider 408.

The user interface unit 440 serves as a graphic user interface (GUI) displayed to a user in the mobile device.

The system setting unit 450 manages various data required for operating the smart wallet service module 410.

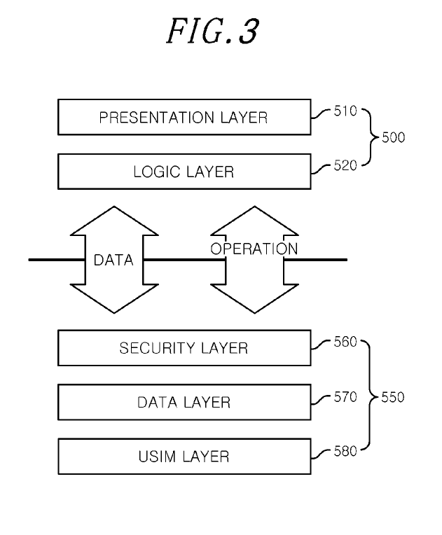

A layer structure for operating the smart wallet service module 410 will be described with reference to FIG. 3.

FIG. 3 is a logic structure diagram illustrating an operation of the smart wallet service in accordance with the embodiment of the present invention.

Referring to FIG. 3, the operation of the smart wallet service module 410 is performed through five-step layers, and the five-step layers are roughly divided into a utilization and management process 500 of a upper layer and a security and storage process 550 of a lower layer.

The utilization and management process 500 includes a presentation layer 510 and a logic layer 520.

The presentation layer 510 serves to process a user interface which receives an input from a user and outputs a result to display them. The presentation layer 510 may be used only when it is necessary to process a service through an interaction with the user.

The logic layer 520 serves to support a cooperation and interaction between calculations and services, receive data from the lower layer, additionally process the received data, and provide the results to the presentation layer 510.

The security and storage process 550 includes a security layer 560 for handling security, a data layer 570 for storing and managing data, and a USIM layer 580 for controlling the USIM 490 mounted in the mobile device.

The security layer 560 handles security such as user authentication and risk-based authentication and provides a function for using an authenticated certificate.

The data layer 570 handles a process of storing data in the database 470 and managing the stored data.

The USIM layer 580 manages credit card information required for on/off line payment and participates in issuing the credit card.

As described with reference to FIG. 2, the upper and lower layers 500 and 550 may be configured in such a manner that data is delivered through the contents provider 420 and an operation is called and communicated through the service interface 460.

In accordance with the embodiments of the present invention, as the mobile ID management and security technology is provided through the smart wallet service module for managing mobile identities in a mobile device, it is possible to reduce an illegal use and privacy violation caused by a loss or theft of mobile IDs. Furthermore, it is possible to consistently provide a user interface and personal information protection in a service based on authentication, payment, and personal information.

Furthermore, ID technology for each purpose may be provided to eliminate an adverse effect of leakage and illegal use while maintaining the benefit of a public identifier. Furthermore, a function of substituting for a public identifier even on an off line may be provided, and a function of safely supporting purchase in a variety of mobile payment environments may be provided.

Finally, the mobile-ID-based personalized service technology may be provided to develop a delicate customized service based on a wide range of personal information such that a user actively manages his/her own information. Therefore, the personal information protection may be significantly strengthened. Furthermore, as an open API for using a mobile ID is provided, it is possible to prevent duplicate development during the development of ID-based personalized service and reduce the cost and time.

While the invention has been shown and described with respect to the preferred embodiments, it will be understood by those skilled in the art that various changes and modifications may be made without departing from the scope of the invention as defined in the following claims.

What is claimed is:

1. A smart wallet service module for use in a mobile device comprising:
a management unit for installing, activating, and terminating a smart wallet service or receiving and managing a user's setting;
a security unit for providing an authentication service through an authenticated certificate or electronic signature;
a storage unit for storing data in a database and managing the stored data; and
a functional unit connected to a storage medium and providing a service related to electronic commerce or credit card issuing.

2. The smart wallet service module of claim 1, wherein the smart wallet service module is connected to a user interface unit and an input/output unit of the mobile device through a contents provider for supporting access to the information stored in the database and a service interface for supporting a function of on/off line payment or credit card issuing.

3. The smart wallet service module of claim 1, wherein the functional unit is connected to the storage medium through a universal IC card (UICC) API and provides the service related to electronic commerce and credit card issuing.

4. The smart wallet service module of claim 1, wherein the storage medium comprises a universal subscriber identity unit (USIM).

5. A layer structure for operating a smart wallet service module, comprising:
an upper layer and a lower layer,
wherein the upper layer includes:
a presentation layer for processing a user interface which receives an input from a user and outputs a result; and
a logic layer for processing a cooperation and interaction between calculations and services, receiving data from the lower layer, and providing a result obtained by processing the received data to the presentation layer,
wherein the lower layer includes:
a security layer for handling security;
a data layer for storing and managing data; and
a USIM layer for controlling a USIM mounted in a mobile device.

6. The layer structure of claim 5, wherein the security layer handles security of user authentication and risk-based authentication, and provides a function for using an authenticated certificate.

7. The layer structure of claim 5, wherein the USIM layer manages credit card information required for on/off line payment, and provides a function related to credit card issuing.

8. The layer structure of claim 5, wherein the layer structure is divided into a utilization and management processor comprising the presentation layer and the logic layer and a security and storage processor comprising the security layer, the data layer, and the USIM layer, and
data transmission and reception between the use and management processor and the security and storage processor is performed through a contents provider inside the mobile device, and an operation between the use and management processor and the security and storage processor is performed through a service interface inside the mobile device.
